(19) United States
(12) Patent Application Publication
(10) Pub. No.: US 2021/0038958 A1
(43) Pub. Date: Feb. 11, 2021

(54) CORNHOLE MAGNET RECEPTIVE BOARD WRAP AND MAGNETIC CORNHOLE WRAPS

(71) Applicant: Shirley I. Kowtko, Hartland, MI (US)

(72) Inventor: Shirley I. Kowtko, Hartland, MI (US)

(21) Appl. No.: 16/683,038

(22) Filed: Nov. 13, 2019

Related U.S. Application Data
(60) Provisional application No. 62/883,810, filed on Aug. 7, 2019.

(51) Int. Cl. A63B 63/08

(52) U.S. Cl. CPC A63B 63/08; A63B 2067/063

(57) ABSTRACT

A magnetized cover for a cornhole board is provided. The cover is magnetic or magnetically attractable and cut to the size of the cornhole board surface and attached to the board by means of a magnetic surface positioned on the cornhole board. This invention makes is possible to cover and recover the top of a cornhole board with little effort. This invention allows the option of applying and changing printed cover designs on a cornhole board's surface.

### CROSS REFERENCE TO RELATED APPLICATION

This application claims priority to Provisional Patent Application No. 62/883,810 filed Aug. 7, 2019.

### FIELD OF THE INVENTION

The present invention relates to game boards. More specifically, the invention relates to a removable, indicia bearing overlay for a cornhole board.

### BACKGROUND OF THE INVENTION

Cornhole or corn toss is similar to horseshoes except contestants use wooden boxes called cornhole platforms and corn bags instead of horseshoes and metal stakes. Contestants take turns pitching their corn bags at the cornhole platform until a contestant reaches the score of 21 points.

The popularity of the game has significantly increased in the past 20 years, moving from a campground game to a game with sanctioned tournaments appearing on national televised sports networks. Many restaurants and parks have areas dedicated to the game and, due to the relatively low cost of the cornhole platforms and bags, many individuals own game sets for personal use.

Many times, due to the portable nature of the game sets, cornhole is played at remote locations, such as a grass lot outside a restaurant. In these situations, it is often desirable to change the “cover design” of the board by adding indicia, a logo, or other marking associated with e.g., a restaurant.

In the prior art, the only way to change, add or apply a cornhole board design was by using vinyl, paint, stain, or direct print on the cornhole board, none of which are easily removable or changeable without extensive manual labor.

This invention of a magnetic cornhole cover requires less effort and experience to add or remove a design from a cornhole game surface. This invention allows the option of applying and exchanging magnetic cover designs that go on the cornhole board's playing surface.

This invention makes is possible to cover and recover the top of a cornhole board with little effort. This invention allows the option of applying and changing magnetic media printed cover designs on a cornhole board's surface.

A magnetized cover for a cornhole board is provided. The cover is produced with printed media then cut to the size of the cornhole board surface and attached to the board by means of a magnetic receptive surface. The magnetic receptive surface is positioned onto the cornhole board apparatus to provide an attachment surface for the magnetized cover. This invention makes is possible to cover and recover the top of a cornhole board with little effort. This invention allows the option of applying and changing magnetic media printed cover designs on a cornhole board's surface.

### SUMMARY OF THE INVENTION

It is a major object of the invention to provide a removable cover for a board game.

It is another object of the invention to provide a removable cover for a cornhole board game.

It is another object of the invention to provide a removable cover for a cornhole board game with pre-printed indicia.

It is another object of the invention to provide a magnetically attachable cornhole board cover.

### BRIEF DESCRIPTION OF THE DRAWINGS

FIG. 1 shows a perspective view of a cornhole board apparatus with the inventive cover attached.

FIG. 2 shows a plan view of the board cover of the invention.

FIG. 3 shows a side view, partly in section, of a cornhole board apparatus with the inventive cover being applied.

### DETAILED DESCRIPTION

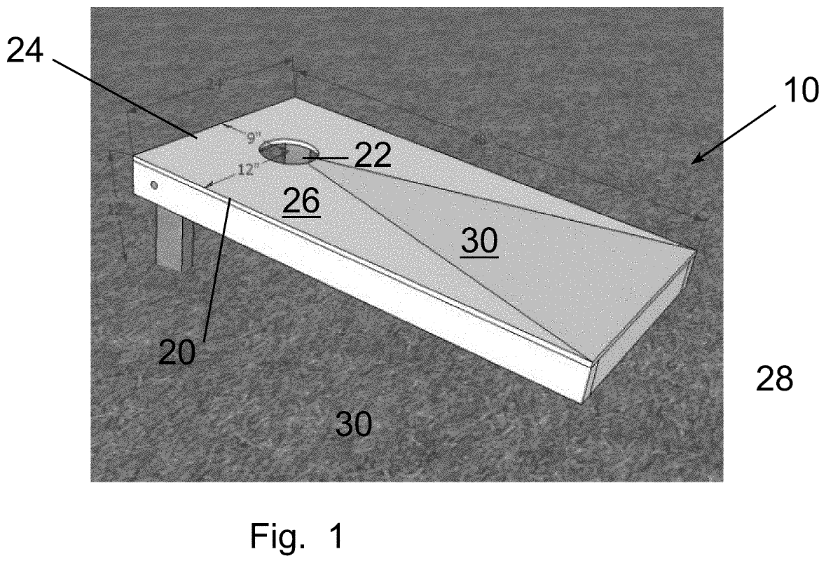

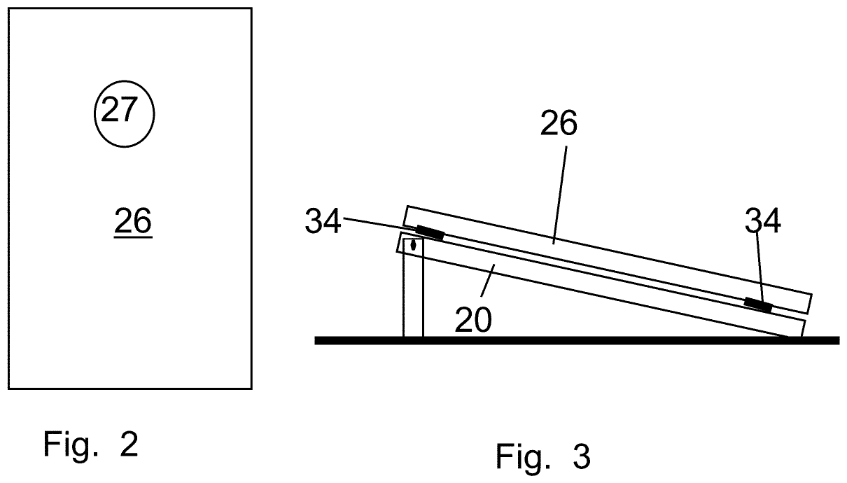

Referring now especially to FIG. 1, a typical cornhole apparatus, generally indicated by the numeral 10, is shown. It can be seen the apparatus 10 comprises a gently sloping nearly horizontal hoard 20 approximately two feet wide and four feet deep having a hole 22 near the rear 24 of the board. This gameboard has a playing surface 26 which is supported approximately four inches above ground level at the front 28 and twelve inches above the ground at the rear 24. The game utilizes two such apparatuses spaced approximately 30 feet apart and multiple bean bags as, for example, four bean bags per participant. The bean bags are of differing color for each participant. The game is played much like horseshoes in that the participants stand beside one of the gameboards and pitch the bean bags toward the second or other one of the boards, attempting to place the bag either on the playing surface 26 of the second board for a score of one point or in the hole 22 for a score of three points. After both participants have alternately tossed their bags toward the second board, the difference in score between the two participants is added to the score of that participant who scored the highest points in that series of tosses. As for example, if the first participant scores three points with his four bags, and the other or second participant scores five points, then the second participant adds two points to his score, whereupon the two participants move to the second board and pitch their bags back toward the first board. This procedure is followed until one of the participants reaches game score as, for example, a score of 21 points.

As previously mentioned, there is sometimes a need to modify the playing surface 26. The scoring is based on the number of tosses and the location of the beanbags after the tosses. However, indicia may be placed on the playing surface 26 for various reasons. For example, a business may want to place a logo or other advertising indicia on the playing surface. Also, as can be seen in FIG. 1, aiming or alignment indicia 30 may be used to help players aim the bean bags. Finally, one may wish to create scoring zones on the playing surface, for the purpose of introducing new rules/scoring systems to the game.

Previously, the only way to modify the appearance of the playing surface 26 was by painting or positioning decals etc. The present invention provides a replaceable playing surface 26 or covering board for a cornhole apparatus. It should first be noted that cornhole can be played using only hoard 20 with no indicia thereon. However, given that cornhole tournaments are often conducted at local businesses, carnivals etc., it is almost always desirable to put some type of indicia on the board 20. To that end, a removable cover or playing surface 26 is provided by the present invention. The surface 26 can have the aiming indicia shown in FIG. 1 thereon. The covering board or surface 26 will have an opening 27 formed therein, the size and positioning of which correspond exactly to the size and positioning of hole 22 formed in board 20 so that when overlaid, a beanbag thrown therethrough is unimpeded as if there were only one hole. In a preferred embodiment the surface 26 is the surface of, essentially, a flat board formed at least partially of magnetic material. The magnetic material of board/surface 26 is magnetized at specific points 34 along the edges of the underside of the board 26. Alternatively, the entire board 26 is magnetized. The indicia 30 may then be positioned onto the surface 26 by any means for creating markings on a surface. An attachment board 29 is positioned atop board 20, the attachment board magnetized to provide a “permanent” attachment means for board 26. The attachment board 29 may be attached by nail, screws or other fasteners.

In use, the apparatus 10 is prepared to accept the changeable covering board/surface 26 by first applying attachment board 29 to hoard 20. In lieu of attachment board 29, magnetic paint or equivalent may be positioned onto board 20. The apparatus 10 may then be transported to the game site, with or without board 26. The board 26 can have any media printed thereon as discussed above. The board 26 can be stored with other boards 26 in a relatively compact space at the game site since boards 26 are flat panels that can be stacked. Of course, the apparatus 10 and boards 26 can be stored in the same location, but unless the apparatus 10 is collapsible this will take a lot of space, which space is typically not available for small venues. To set up for game play, board 26 is positioned over board 20 via attachment board 27 until the edges of the respective boards are aligned. Magnetic attraction will secure board 26 onto board 20 via magnetized areas 34 of attachment hoard 29.

It is to be understood that the present invention is not limited to the sole embodiment described above, but encompasses any and all embodiments within the scope of the following claims:

I claim:

1. A method of configuring a cornhole apparatus for play comprising the steps of:
preparing a first planar surface of a predetermined length and width and at least partially magnetized or formed of metal, and supporting said surface in angled relation to ground by way of vertical supports;
forming an opening in said first planar surface;
preparing a second planar surface of said predetermined length and width and forming an opening therein, said opening corresponding in size and position to the opening in the first planar surface, said second planar surface at least partially magnetized;
preparing a third planar surface and printing indicia or markings onto said third planar surface;
placing said third planar surface above said second surface and aligning the edges of said surfaces.
